(19) United States
(12) Patent Application Publication
(10) Pub. No.: US 2024/0401210 A1
(43) Pub. Date: Dec. 5, 2024

(54) SYNTHESIS OF TRANSITION METAL HYDROXIDES, OXIDES, AND NANOPARTICLES THEREOF

(71) Applicant: Aspen Aerogels, Inc., Northborough, MA (US)

(72) Inventor: Hooman YAGHOOBNEJAD ASL, Hudson, MA (US)

(21) Appl. No.: 18/697,678

(22) PCT Filed: Mar. 30, 2023
(86) PCT No.: PCT/US2023/016824

§ 371 Date: Apr. 1, 2024

Related U.S. Application Data
(60) Provisional application No. 63/378,756, filed on Oct. 7, 2022.
(60) Provisional application No. 63/326,353, filed on Apr. 1, 2022.

(51) Int. Cl. C25B 1/14; C01G 49/00; C25B 11/046; C25B 11/075; C25B 15/08; H01M 10/0525; H01M 10/44

(52) U.S. Cl. CPC C25B 1/14; C01G 49/009; C25B 11/046; C25B 11/075; C25B 15/081; H01M 10/0525; H01M 10/44; C01P 2004/62; C01P 2004/64; C01P 2006/12

(57) ABSTRACT

Techniques are disclosed for electrochemical synthesis of rechargeable battery cathode precursor materials using a porous carbon element. The porous carbon element acts as an air cathode to reduce oxygen. Reduced oxygen species may oxidize a transition metal anode, thereby facilitating a room temperature redox reaction with transition metals, including those that are generally resistant to corrosion, such as nickel. The transition metal reaction product(s) may be further processed into rechargeable battery cathode materials without also synthesizing hazardous waste products.

### CROSS REFERENCES TO RELATED APPLICATIONS

This application claims priority to and the benefit of U.S. Provisional Patent Application No. 63/326,353 filed Apr. 1, 2022 entitled “Oxidation of Metals and Alloys Using a Carbon Aerogel Counter Electrode” and U.S. Provisional Patent Application No. 63/378,756 filed Oct. 7, 2022 entitled “Oxidation of Metals and Alloys Using a Porous Carbon Counter Electrode” both of which are herein incorporated by reference in their entirety

### TECHNICAL FIELD

The present disclosure relates to the synthesis of oxide and hydroxide nanomaterials of certain metals that are used in a variety of applications, for example to produce rechargeable battery compositions. In particular, the present disclosure relates to synthesis of transition metal hydroxides and oxides, and nanoparticles thereof.

### BACKGROUND

Transition metal oxides and hydroxides have many important industrial applications, including as precursors for rechargeable battery cathode materials. However, conventional processes for synthesizing transition metal oxides and hydroxides generally produce large amounts of hazardous waste. Similarly, microparticles and nanoparticles that include iron are used in a variety of industrial processes. In particular, iron microparticles and nanoparticles may be preferred in applications in which a high specific surface area (e.g., meters² (m²)/gram (g)) is desired.

However, conventional processes to produce nanoparticles of metals, for example iron, generally are energy intensive, time consuming, expensive and may still not produce particles that are sufficiently small or have a monodisperse particle size.

### BRIEF DESCRIPTION OF THE DRAWINGS

The disclosure is illustrated by way of example and not by way of limitation in the figures of the accompanying drawings. It should be noted that references to “an” or “one” embodiment or aspect in this disclosure are not necessarily to the same embodiment or aspect, and they mean at least one. In the drawings:

FIG. 1 schematically illustrates a system for oxidizing transition metals using a porous carbon element, in accordance with one or more aspects of the disclosure;

FIG. 2 schematically illustrates an electrochemical cell for oxidizing transition metals using a porous carbon element, in accordance with one or more aspects of the disclosure;

FIG. 3 is an experimentally determined graph showing a relationship between an electrical potential applied to the system of FIG. 1 with Ni metal (Ni) as the anode and a resulting current, in accordance with one or more aspects of the disclosure;

FIG. 4 is a schematic illustration of a transition metal component having a layered oxidized composition, in accordance with one or more aspects of the disclosure; and

FIGS. 5A, 5B, and 5C are experimentally determined graph showing a relationship between an electrical potential applied to a system analogous to the system schematically depicted in FIG. 1 and a resulting current for aluminum (Al), zinc (Zn), and tin (Sn), in accordance with one or more aspects of the disclosure.

### DETAILED DESCRIPTION

In the following description, for the purposes of explanation, numerous specific details are set forth in order to provide a thorough understanding. One or more aspects may be practiced without these specific details. Features described in one embodiment or aspect of the disclosure may be combined with features described in a different embodiment. In some examples, well-known structures and devices are described with reference to a block diagram form in order to avoid unnecessarily obscuring the present invention.

Before describing several example aspects of the disclosed technology, it is to be understood that the technology is not limited to the details of construction or process steps set forth in the following description. The technology is capable of other implementations and of being practiced or being carried out in various ways.
1. GENERAL OVERVIEW
2. EXPLANATION OF TERMINOLOGY
3. POROUS CARBON COMPONENTS
   3.1 AEROGEL-DERIVED CARBON COMPONENTS
   3.2 OTHER POROUS CARBON COMPONENTS
4. CATHODE COMPOSITION SYNTHESIS CHALLENGES
5. ROOM TEMPERATURE OXIDATION OF NICKEL
6. LAYERED TRANSITION METAL ELECTRODE MATERIALS
7. SYNTHESIZING POROUS METAL OXIDE MATERIALS
8. EXPERIMENTAL EXAMPLE
9. PRODUCTION OF MAGNETIC IRON OXIDE NANOPARTICLES (IONPS) PRECURSOR FOR LFP
10. PRODUCTION OF NON-MAGNETIC IRON OXIDE NANOPARTICLES (IONPS) PRECURSOR FOR LFP

### 1. GENERAL OVERVIEW

One or more aspects include techniques by which transition metals may be oxidized at room temperature using an electrolyte and a porous carbon component. The porous carbon element may act as an “air cathode” that reduces oxygen, thereby causing oxygen to act as a cathode in an electrochemical cell with a transition metal anode. In this way, aspects described herein facilitate a room temperature redox reaction with transition metals. Some aspects described herein may oxidize transition metals that are resistant to corrosion, such as nickel. Aspects of the process described herein may react bulk transition metals (and/or their alloys) at room temperature with oxygen via a porous carbon component (or equivalently, porous carbon element) that reduces the activation energy needed for the reduction of oxygen. The transition metal reaction product(s) may be further processed into rechargeable battery cathode materials without also synthesizing hazardous waste products. In some examples, magnetic and/or non-magnetic nanoparticles of iron oxide are produced. In some examples, the iron oxide nanoparticles have high, and even unexpectedly high, specific surface area as measured in meters² (m²)/gram (g)

For convenience of explanation, aspects that are related to active materials for a rechargeable battery, the term “cathode” is used to refer to a battery component that is oxidized during charging (e.g., Co³⁺ to Co⁴⁺) and is reduced during discharging (e.g., Co⁴⁺ to Co³⁺). The term “anode” is used to refer to a battery component that is reduced during charging (e.g., from C to LiC₆) and is oxidized during discharging (e.g., from LiC₆ to C). Furthermore, for brevity the term “transitional metal” also includes alloys, intermetallic compounds, and other combinations of multiple transition metals.

One or more aspects described in this Specification and/or recited in the claims may not be included in this General Overview section.

### 2. EXPLANATION OF TERMINOLOGY

With respect to the terms used in this disclosure, the following definitions are provided. This application will use the following terms as defined below unless the context of the text in which the term appears requires a different meaning.

The articles “a” and “an” are used herein to refer to one or to more than one (i.e., to at least one) of the grammatical object of the article. The term “about” used throughout this specification is used to describe and account for small fluctuations. For example, the term “about” can refer to less than or equal to ±10%, or less than or equal to ±5%, such as less than or equal to ±2%, less than or equal to ±1%, less than or equal to ±0.5%, less than or equal to ±0.2%, less than or equal to ±0.1% or less than or equal to ±0.05%. All numeric values herein are modified by the term “about,” whether or not explicitly indicated. A value modified by the term “about” of course includes the specific value. For instance, “about 5.0” must include 5.0.

Within the context of the present disclosure, in some examples, the terms “framework” or “framework structure” refer to the network of interconnected oligomers, polymers, or colloidal particles that form the solid structure of a gel or an aerogel. The polymers or particles that make up the framework structures typically have a diameter of about 100 angstroms. In examples of pyrolyzed or carbonized aerogels, the terms “framework” or “framework structure” refer to the interconnected network of linear fibrils, that may be connected together at nodes to form a framework that defines pores.

As used herein, the terms “aerogel,” and “aerogel material” refer to a solid object, irrespective of shape or size, comprising a framework of interconnected solid structures, with a corresponding network of interconnected pores integrated within the framework, and containing gases such as air as a dispersed interstitial medium. As such, aerogels are open non-fluid colloidal or polymer networks that are expanded throughout their whole volume by a gas, and are formed by the removal of all swelling agents from a corresponding wet-gel without substantial volume reduction or network compaction. Aerogels are generally characterized by the following physical and structural properties (according to nitrogen porosimetry testing and helium pycnometry) attributable to aerogels: (a) an average pore diameter ranging from about 2 nm to about 100 nm; (b) a porosity of at least 60% or more, and (c) a specific surface area of about 1, about 10, or about 20, to about 100 or about 1000 m²/g by nitrogen sorption analysis. It can be understood that the inclusion of additives, such as a reinforcement material or an electrochemically active species, for example, silicon, may decrease porosity and the specific surface area of the resulting aerogel composite. Densification may also decrease porosity of the resulting aerogel composite. Aerogel materials of the present disclosure (e.g., polyimide and carbon aerogels) include any aerogels which satisfy the defining elements set forth in the previous paragraph.

Aerogel materials of the present disclosure thus include any aerogels or other open-celled compounds, which satisfy the defining elements set forth in previous paragraphs, including compounds, which can be otherwise categorized as xerogels, cryogels, ambigels, microporous materials (e.g., polymer foams), and the like.

As used herein, the term “xerogel” refers to a gel comprising an open, non-fluid colloidal or polymer networks that is formed by the removal of all swelling agents from a corresponding gel without any precautions taken to avoid substantial volume reduction or to retard compaction. A xerogel generally comprises a compact structure. Xerogels suffer substantial volume reduction during ambient pressure drying and generally have a porosity of about 40% or less.

### 3. POROUS CARBON COMPONENTS

In certain examples, the present disclosure involves the formation and use of nanoporous carbon-based scaffolds or structures, such as carbon aerogels, as electrode materials in an electrochemical cell to synthesize transition metal oxides, hydroxides, and nanoparticles thereof. Examples of porous carbon components of the present disclosure include, but are not limited to, carbonized aerogel materials (e.g., carbonized polyimide aerogel, carbonized polyamic acid aerogel) and carbonized polymer foams (e.g., carbonized polyurethane foam). For convenience, carbonized aerogels are sometimes equivalently referred to as “carbon aerogels” herein.

Furthermore, it is contemplated herein that the porous carbon materials, including carbon aerogels, can take the form of monolithic structures. The monolithic porous carbon has not need for a distinct binder material; in other words, the air cathode can be binder-less. As used herein, the term “monolithic” refers to porous carbon materials in which a majority (by weight) of the carbon included in the carbon material or composition is in the form of a unitary, continuous, interconnected carbon structure. In the specific example of carbonized aerogel materials, this may include an interconnected aerogel nanostructure. Monolithic aerogel materials include aerogel materials which are initially formed to have a unitary interconnected gel or aerogel nanostructure, but which can be subsequently cracked, fractured or segmented into non-unitary aerogel nanostructures.

Monolithic porous carbon materials are differentiated from particulate porous carbon materials. The term “particulate porous carbon material” refers to porous carbon materials in which a majority (by weight) of the carbon included in the carbon material is in the form of particulates, particles, granules, beads, or powders, which can be combined together (i.e., via a binder, such as a polymer binder) or compressed together but which lack an interconnected structure between individual particles. Collectively, materials of this form will be referred to as having a powder or particulate form (as opposed to a monolithic form). It should be noted that despite an individual particle of a powder having a unitary structure, the individual particle is not considered herein as a monolith.

Within the context of the present disclosure, the terms “binder-less” or “binder-free” (or derivatives thereof) refer to a material being substantially free of binders or adhesives to hold that material together. For example, a monolithic nanoporous carbon material is free of binder since its framework is formed as a unitary, continuous interconnected structure. Advantages of being binder-less include avoiding any effects of binders, such as on electrical conductivity and pore volume. On the other hand, aerogel particles require a binder to hold together to form a larger, functional material; such larger material is not contemplated herein to be a monolith. In addition, this “binder-free” terminology does not exclude all uses of binders. For example, a monolithic aerogel, according to the present disclosure, may be secured to another monolithic aerogel or a non-aerogel material by disposing a binder or adhesive onto a major surface of the aerogel material. In this way, the binder is used to create a laminate composite and provide electrical contact to a current collector, but the binder has no function to maintain the stability of the monolithic aerogel framework itself.

### 3.1 Aerogel-Derived Porous Carbon Components

In some examples, a carbonized aerogel may be used as the porous carbon element in the systems and methods described herein. Carbonized aerogels may be formed by carbonizing some compositions of organic polymer aerogels. One example of a carbonizable organic polymer aerogel is that of polyimide. Other examples of porous carbon sources are identified below.

Methods of forming a polyimide gel or aerogel include those in which a polyimide gel is prepared in an organic solvent solution from condensation of a diamine and a tetracarboxylic acid dianhydride to form a polyamic acid and dehydration of the polyamic acid. See, for example, U.S. Pat. Nos. 7,071,287 and 7,074,880 to Rhine et al., and U.S. Patent Application Publication No. 2020/0269207 to Zafiropoulos, et al.

Production of an aerogel, according to certain aspects, includes the following steps: i) formation of a solution containing a gel precursor; ii) formation of a gel from the solution; and iii) extracting the solvent from the gel materials to obtain a dried aerogel material.

In one example, a polyimide aerogel is formed by combining at least one diamine and at least one dianhydride in a common polar aprotic solvent(s). Additional details regarding polyimide gel/aerogel formation can be found in U.S. Pat. Nos. 7,074,880 and 7,071,287 to Rhine et al.; U.S. Pat. No. 6,399,669 to Suzuki et al.; U.S. Pat. No. 9,745,198 to Leventis et al.; Leventis et al., Polyimide Aerogels by Ring-Opening Metathesis Polymerization (ROMP), Chem. Mater. 2011, 23, 8, 2250-2261, among others, each of which is incorporated herein by reference in its entirety.

Nanoporous carbons, such as carbon aerogels, according to the present disclosure, can be formed from any suitable organic precursor materials. Examples of such materials include, but are not limited to, RF (resorcinol-formaldehyde), PF (phenol-furfural), PI (polyimide), polyamides, polyoxyalkylene, polyurethane, polyacrylonitrile, cresol formaldehyde, polyisocyanate, polyvinyl alcohol dialdehyde, polyisocyanurates, various epoxide resins, chitosan, and combinations and derivatives thereof. In some examples, the carbon aerogel is formed from a pyrolyzed/carbonized polyimide-based aerogel, i.e., the polymerization of polyimide. Even more specifically, the polyimide-based aerogel can be produced using one or more methodologies described in U.S. Pat. Nos. 7,071,287 and 7,074,880 to Rhine et al., e.g., by imidization of poly(amic) acid and drying the resulting gel using a supercritical fluid.

Carbonized aerogels of the present disclosure, e.g., polyimide-derived carbon aerogels, can have a residual “hetero-atom” (i.e., non-carbon atom) nitrogen content of at least about 1 wt % as determined by elemental analysis. For example, carbon aerogels can have a residual nitrogen content of at least about 1 wt %, and up to about 10 wt %. In some aspects, the residual nitrogen content is about 1, about 2, about 3, about 4, about 5, about 6, about 7, about 8, about 9, or about 10 wt %.

In examples of the present disclosure, a dried polymeric aerogel composition can be subjected to a treatment temperature of 200° C. or above, 400° C. or above, 600° C. or above, 800° C. or above, 1000° C. or above, 1200° C. or above, 1400° C. or above, 1600° C. or above, 1800° C. or above, 2000° C. or above, 2200° C. or above, 2400° C. or above, 2600° C. or above, 2800° C. or above, or in a range between any two of these values, for carbonization of the organic (e.g., polyimide) aerogel. In some examples, the material is carbonized in the absence of oxygen and/or in a reducing environment. Exposure to this temperature can convert the dried polymeric aerogel into a carbonized aerogel. In exemplary aspects, a dried polymeric aerogel composition can be subjected to a treatment temperature in the range of about 1000° C. to about 1100° C., e.g., at about 1050° C. Without being bound by theory, it is contemplated herein that the electrical conductivity of the aerogel composition increases with carbonization temperature. In some examples, some compositions or types of aerogels will become conductive when carbonized above a threshold carbonization temperature (e.g., above 400° C., above 500° C., above 600° C.).

In some examples, carbonized aerogels, such carbonized polyimide aerogels and carbonized poly(amic) acid aerogels can be mechanically strong, exhibiting a Young's Modulus that is unexpectedly high for carbonized materials. In certain aspects, carbonized aerogel materials or compositions of the present disclosure have a Young's modulus of about 0.2 GPa or more, 0.4 GPa or more, 0.6 GPa or more, 1 GPa or more, 2 GPa or more, 4 GPa or more, 6 GPa or more, 8 GPa or more, or in a range between any two of these values. Young's modulus may be determined by methods known in the art, for example including, but not limited to: Standard Test Practice for Instrumented Indentation Testing (ASTM E2546, ASTM International, West Conshocken, PA); or Standardized Nanoindentation (ISO 14577, International Organization for Standardization, Switzerland). Within the context of the present disclosure, measurements of Young's modulus are acquired according to ASTM E2546 and ISO 14577, unless otherwise stated.

Within the context of the present disclosure, the term “pore size distribution” refers to the statistical distribution or relative amount of each pore size within a sample volume of a porous material. A narrower pore size distribution refers to a relatively large proportion of pores at a narrow range of pore sizes, thus enhancing the amount of pores that can surround the electrochemically active species and maximizing use of the pore volume. Conversely, a broader pore size distribution refers to relatively small proportion of pores at a narrow range of pore sizes. As such, pore size distribution can be measured as a function of pore volume and recorded as a unit size of a full width at half max of a predominant peak in a pore size distribution chart. The pore size distribution of a porous material may be determined by methods known in the art, for example including, but not limited to, surface area and porosity analyzer by nitrogen adsorption and desorption from which pore size distribution can be calculated. Within the context of the present disclosure, measurements of pore size distribution are acquired according to this method, unless otherwise stated. In some examples, aerogel materials or compositions of the present disclosure have a relatively narrow pore size distribution (full width at half max) of about 50 nm or less, 45 nm or less, 40 nm or less, 35 nm or less, 30 nm or less, 25 nm or less, 20 nm or less, 15 nm or less, 10 nm or less, 5 nm or less, or in a range between any two of these values.

Within the context of the present disclosure, the term “pore volume” refers to the total volume of pores within a sample of porous material. Pore volume is specifically measured as the volume of void space within the porous material, where that void space may be measurable and/or may be accessible by another material, for example an electrochemically active species such as silicon particles. It can be recorded as cubic centimeters per gram (cm³/g or cc/g). The pore volume of a porous material may be determined by methods known in the art, for example including, but not limited to, surface area and porosity analyzer by nitrogen adsorption and desorption from which pore volume can be calculated. Within the context of the present disclosure, measurements of pore volume are acquired according to this method, unless otherwise stated. In certain examples, aerogel materials or compositions of the present disclosure (including carbonized aerogels) have a relatively large pore volume of about 0.5 cc/g or more, 1 cc/g or more, 1.5 cc/g or more, 2 cc/g or more, 2.5 cc/g or more, 3 cc/g or more, 3.5 cc/g or more, 4 cc/g or more, or in a range between any two of these values.

Within the context of the present disclosure, the term “porosity” refers to empty space within an aerogel sample as a fraction of the total (envelope) volume of the aerogel sample. Porosity may be calculated by methods known in the art, for example including, but not limited to, skeletal density minus bulk density divided by the skeletal density. Skeletal density may be measured by helium pycnometry, among other methods. Bulk density may be determined by a ratio of weight to geometric volume of an aerogel sample. Within the context of the present disclosure, measurements of porosity are acquired according to this method, unless otherwise stated. In certain aspects, aerogel materials or compositions of the present disclosure have a porosity of about 99% or less, 80% or less, 70% or less, 60% or less, 50% or less, 40% or less, 30% or less, 20% or less, 10% or less, or in a range between any two of these values.

Within the context of the present disclosure, the term “pore size at max peak from distribution” refers to the value at the discernible peak on a graph illustrating pore size distribution. Pore size at max peak from distribution is specifically measured as the pore size at which the greatest percentage of pores is formed. It can be recorded as any unit length of pore size, for example m or nm. The pore size at max peak from distribution may be determined by methods known in the art, for example including, but not limited to, surface area and porosity analyzer by nitrogen adsorption and desorption from which pore size distribution can be calculated and pore size at max peak can be determined. Within the context of the present disclosure, measurements of pore size at max peak from distribution are acquired according to this method, unless otherwise stated. Aerogel materials or compositions of the present disclosure can have a pore size at max peak from distribution of about 150 nm or less, 140 nm or less, 130 nm or less, 120 nm or less, 110 nm or less, 100 nm or less, 90 nm or less, 80 nm or less, 70 nm or less, 60 nm or less, 50 nm or less, 40 nm or less, 30 nm or less, 20 nm or less, 10 nm or less, 5 nm or less, 2 nm or less, or in a range between any two of these values.

### 3.2 Other Porous Carbon Components

Porous carbons of the present disclosure are not limited to carbonized aerogels. Other porous carbons that exhibit sufficient chemical activity to reduce oxygen in the systems described herein may also be used. In some examples, conventional polymer foams may be carbonized and used in any of the examples described herein. In one experimental example, a carbonized polyurethane foam was used to generate nickel hydroxide. In another example, a carbonized polyurethane foam was used to synthesize nanoparticles of iron oxide. It will be appreciated that other polymers that lend themselves to carbonization (e.g., those containing backbones with phenyl rings, unsaturated bonds, and other similar structures) may be foamed or synthesized to have a porous structure, and may subsequently be used in the systems and examples described herein. The carbonization techniques described above in Section 3.1 are applicable to carbonizing non-aerogel materials, namely heating the polymer to a carbonization temperature in the absence of oxygen.

### 4. CATHODE COMPOSITION SYNTHESIS CHALLENGES

Many common types of rechargeable batteries, such as lithium-ion batteries (“LIB”), use transition metal oxides and/or hydroxides as precursors to rechargeable battery cathode materials. Early generations of rechargeable LIB cathode materials relied on cobalt (Co) as the predominant transition metal. However, successive generations of rechargeable batteries have progressively reduced the amount of cobalt in cathode materials. For example, many early rechargeable battery compositions used cobalt exclusively as the multivalent transition metal in the cathode composition (e.g., lithium cobalt oxide (LiCoO₂)). However, more recent compositions of cathode materials have replaced some cobalt with nickel and other substituents. Examples of cathode compositions that include both nickel and cobalt include, but are not limited to, LiNi_{1/3}Co_{1/3}Mn_{1/3}O₂ (“NCM 111”) and LiNi_{0.8}Co_{0.1}Mn_{0.1}O₂ (“NCM 811”).

Replacing cobalt with other transition metals has a number of benefits. For example, cobalt is known to be environmentally toxic and also known to pose various threats to human health. Replacing cobalt with other materials that are less toxic and/or pose less risk to health may reduce environmental and health risks associated with the production, use, and disposal of rechargeable batteries. In some examples, replacing cobalt with other materials may also reduce the cost of rechargeable batteries (e.g., on a per unit of stored energy basis, on a per charge/discharge cycle basis). Furthermore, replacing cobalt with other transition metals has additional benefits. Cobalt generally has a financial higher cost that other transition metals and may be mined under socially problematic situations. Using an alternative to cobalt may address these disadvantages.

Precursor materials to nickel, cobalt, and manganese (“NCM”) cathode compositions are generally formed via aqueous synthesis techniques that produce large amounts of wastewater. In some examples, transition metal salts, such as sulfates, are first reacted with potassium hydroxide (KOH) to produce water-insoluble metal hydroxides. These metal hydroxides include, in some examples, Ni(OH)₂ among other transition metal oxides and/or hydroxides. The metal hydroxides are ultimately precipitated from solution into a solid form. These precipitates are washed with deionized water to remove potassium sulfate impurities and then dried. The dried precipitates are then combined with lithium carbonate (Li₂CO₃), and thermally processed to produce a cathode composition (e.g., NCM 111, NCM 811). In some examples, lithium hydroxide is used instead of lithium carbonate for high Ni content cathode materials.

The synthesis of nickel-based transition metal cathode materials has various drawbacks. For example, ammonia (NH₃) is often added to aqueous transition metal solutions, such as those described above. While not wishing to be bound by theory, it is believed that ammonia forms complexes with transition metals in aqueous solution. These complexes are believed to stabilize the transition metal cations in the solution at high pH before a controlled precipitation with hydroxy anions (e.g., OH⁻) happens. This in turn may improve the compositional uniformity of the transition metal precipitates, ultimately improving the compositional uniformity of cathode compositions derived therefrom.

The waste products from the ammonia-containing aqueous solution present hazards to the environment and to human health. For example, these waste products may include NH₃ and K₂SO₄. Both of these waste products require proper handling during processing, remediation, and treatment prior to disposal, all of which increase battery production costs and present environmental disadvantages. Furthermore, the aqueous processes described above are voluminous. Tens or hundreds of liters of waste product may be produced for every 1 kilogram of cathode composition. This large volume of waste product is a significant drawback, particularly given the potential scale of rechargeable battery production when applied to automotive and/or grid power storage applications. An alternative synthesis technique that produces stoichiometrically preferred cathode composition precursors without generating an abundance of hazardous waste would reduce production costs and reduce environmental and human health risks.

Furthermore, aspects described herein also beneficially eliminate the production of waste products used to synthesize the precursors to traditional NCM battery cathode material reaction. For example, nickel sulfate (NiSO₄) used in the aqueous reaction described above may be synthesized by treating metallic nickel, or its hydroxide or carbonate salts, with sulfuric acid. The reaction product NiSO₄ is separated, washed, and dried, all of which require energy and produce pollutants (e.g., sulfuric acid).

### 5. ROOM TEMPERATURE OXIDATION OF NICKEL

Surprisingly, it has been experimentally observed that certain types of porous carbon materials (including carbon aerogels produced according to techniques described above) may act as an “air cathode” to catalytically reduce oxygen at room temperature. When arranged in an electrochemical cell with aqueous electrolytes, oxygen can be reduced into hydroxide anions that can oxidize a transition metal counter-electrode. The techniques described herein may operate effectively even on transition metals normally resistant to oxidation. In some examples, aspects herein may oxidize nickel to produce nickel hydroxide. In some examples, aspects herein may react transition metal components to completion (i.e., completely consume the portions of transition metal in contact with an electrolyte) within a few hours and a room temperature.

The catalytic effect of carbon aerogels and other porous carbons described herein may be used to oxidize nickel in the solid state at room temperature (e.g., from 5° C. to 25° C.). This is unexpected given the kinetic unfavourability of oxidizing nickel beyond its naturally occurring passivation layer and reductive dissociation of the dioxygen into hydroxide. In some examples, aspects described herein may be used to synthesize precursor materials used in rechargeable batteries that include, but are not limited to, NCM111, NCM811, LiNi_{0.8}Co_{0.15}Al_{0.05}O₂ (“NCA 85 15 5”), among others.

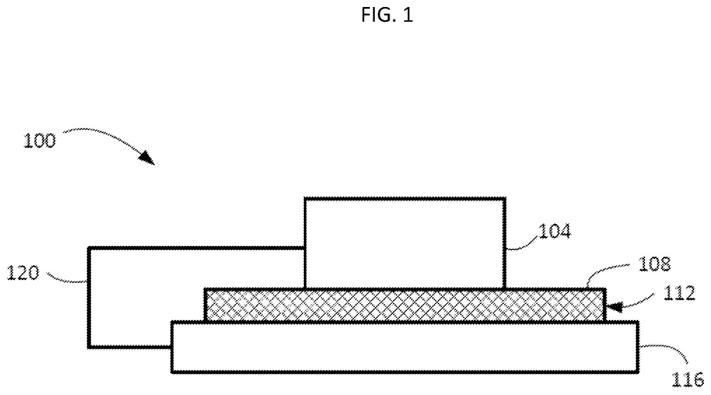

FIG. 1 is a schematic illustration of a system 100 used to oxidize nickel at room temperature, according to one or more aspects described herein. The system 100 includes a porous carbon element 104, a separator 108, electrolyte 112, a transition metal electrode 116, and a conductor 120. In some aspects, the electrode 116 is formed from a non-transition metal (or alloy), such as aluminum, tin, among others.

While not wishing to be bound by theory, it is believed that the porous carbon element 104 may reduce the activation energy for the reduction of oxygen, as described above, thereby enabling the electrically connected transition metal to participate in a room temperature redox reaction. As also described above, room temperature oxidation of transition metals like those used in rechargeable battery cathode materials is unexpected and also has many benefits.

In various aspects, the porous carbon element 104 may be synthesized and/or produced according to the techniques described above. Some aspects of these techniques include pyrolysis of a polyimide-derived carbon aerogel. In some examples, the pyrolyzed polyimide derived carbon aerogel may include residual nitrogen or other heteroatoms (i.e., non-carbon atoms) that are not removed during aerogel synthesis or pyrolysis. Using the porous carbon element 104 as a catalyst to oxidize the transition metal electrode 116 may generate cathode precursor materials that include, but are not limited to nickel oxide (NiO), nickel hydroxide (Ni(OH)₂), NiCO₃ (if CO₂ is present during electrolysis) and analogous compositions for cobalt, manganese, and other transition metals. The process described herein may produce the transition metal cathode precursor materials (e.g., Ni(OH)₂, Co(OH)₂, Mn(OH)₂), among others, in the solid state without producing large quantities of waste water.

In some examples, the transition metal hydroxide using some of the aspects described herein may generate a reaction product that does not require purification and/or washing of contaminants (e.g., NH₃, K₂SO₄, NiSO₄). For examples in which sodium chloride is present in the electrolyte, reaction product may include benign NaCl that may simply be removed by washing the reaction products with water. NaCl is less environmentally polluting and poses a lower threat to human health than the sulfates and ammonia produced by alternative processing techniques. For examples in which the electrolyte includes ammonium chloride (NH₄Cl), remediation is also less problematic than other process. NH₄Cl decomposes to a gaseous mixture of NH₃ and HCl at 338° C. during calcination. The temperature of the gas mixture may be reduced below 338° C. after evolution of the gases so that NH₄Cl condenses back into solid form, which can be recycled. For this reason, an impurity of NH₄Cl salt requires no washing and therefore produces no wastewater.

While not wishing to be bound by theory, in some examples the porous carbon element 104 may reduce the activation energy of transferring an electron from a metal (e.g., the transition metal electrode 116) in electrical communication with the porous carbon to oxygen (via the conductor 120). This reduced activation energy may increase the rate at which a transition metal is oxidized when placed in electrical communication with the porous carbon. In some examples, an electrolyte (e.g., NaCl_{(aq)}) may wet surfaces of the porous carbon element 104. This, in turn may facilitate the generation of hydroxy anions at the porous carbon element 104. The generated hydroxy anions may then diffuse to the transition metal electrode 116 and react with it to produce an oxidized form of the transition metal.

While not wishing to be bound by theory, the high specific surface area of porous carbon element 104 may be a factor in the efficient catalytic reduction of oxygen and subsequent oxidation of an electrolytically connected transition metal electrode 116. For example, porous carbon elements 104 that use carbonized aerogels, examples of which are described above, may have specific surface areas in the range of their non-pyrolyzed aerogel precursors from 100 m²/g to 600 m²/g.

While not wishing to be bound by theory, some examples of the porous carbon element 104 that comprise carbonized aerogels may comprise non-carbon “hetero atoms,” some of which may increase the efficiency by which oxygen is reduced and transition metals subsequently oxidized. For example, some carbon aerogels of the present disclosure derived from pyrolysis of polyimide aerogels may include residual nitrogen. In some examples, a residual nitrogen content of a carbon aerogel may be at least about 4 wt %. For example, carbon aerogels according to aspects disclosed herein can have a residual nitrogen content of at least about 0.1 wt %, at least about 0.5 wt %, at least about 1 wt % at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, or in a range between any two of these values. Other heteroatoms that may participate in the reactions described herein may also include oxygen, hydrogen, graphitic carbon, in some examples.

While not wishing to be bound by theory, some examples of the porous carbon element 104 that comprise carbonized aerogel may have a relatively high electrical conductivity relative to other forms of carbon. The high electrical conductivity of the carbonized aerogel may facilitate the reduction of oxygen. In certain aspects, carbonized aerogel materials or compositions of the present disclosure have an electrical conductivity of about 1 S/cm or more, about 5 S/cm or more, about 10 S/cm or more, 20 S/cm or more, 30 S/cm or more, 40 S/cm or more, 50 S/cm or more, 60 S/cm or more, 70 S/cm or more, 80 S/cm or more, or in a range between any two of these values.

In some examples, the rate of the redox reaction (and more specifically, the oxidation of the transition metal) may be selected (e.g., increased or decreased relative to a reference reaction rate) by modifying one or more conditions under which the reaction is performed. In some examples, the rate of reaction may be increased by one or more of: increasing a temperature at which the reaction is performed, increasing a partial pressure of oxygen (thereby increasing a rate of hydroxy anion production), increasing a concentration of electrolyte (e.g., from a 1 molar (M) solution to a multiple molar solution), and/or increasing the magnitude of the electrical potential difference applied to the porous carbon/transition metal system 100. Similarly, a rate of reaction can be decreased by limiting any of the foregoing parameters. Changing a pH of the electrolyte or the composition of the electrolyte may also affect the rate of the reaction as well as the composition and morphology of the reaction product(s).

The porous carbon element 104 may be in a monolithic form, a particulate form, or combinations thereof.

In some examples, excluding gases other than oxygen may influence the reaction product. For example, using pure oxygen or a mix of gases that excludes carbon dioxide may reduce the presence of carbonate species in the reaction product. This in turn may reduce and/or eliminate the presence of undesired reaction products (e.g., carbonates) in the oxidized transition metal compounds.

The separator 108 is an electrically insulating material that provides a structure through which ions may travel. This combination prevents electrical shorting of the system 100 while enabling current flow via ionic transfer between the porous carbon element 104 and the transition metal electrode 116. Examples of separator 108 may include cellulose-based papers, fibrous polymer fabrics or felts, among others. Also, the separator can be eliminated if the electrodes are held physically apart (such as a flooded cell design).

The electrolyte 112, disposed within the separator 108, facilitates ionic transfer from the porous carbon element 104 to the transition metal electrode 116. Examples of the electrolyte include aqueous (e.g., distilled water, deionized water, distilled deionized water, tap water) solutions of sodium chloride (NaCl_{(aq)}), ammonia chloride (NH₃Cl_{(aq)}), sodium carbonate (NaCO_{3(aq)}), among others. In some examples, a concentration of the electrolyte may be saturated with solute. In other examples, a concentration of the electrolyte may be less than a saturated solution. In some examples, a concentration of the electrolyte may be selected according to various criteria including, but not limited to a desired rate of reaction at the transition metal anode (higher concentrations generally accelerating an oxidation rate), a morphology and/or configuration of the oxide reaction product at the transition metal anode, among others.

While not wishing to be bound by theory, it has been observed that the presence of chloride in the electrolyte promotes separation of the hydroxylated reaction product from the surface of the transition metal electrode 116. Thus, when using a chloride-containing electrolyte, the process may naturally convert an entire mass of the transition metal electrode 116 to the reaction product because a fresh surface of the transition metal electrode 116 is naturally exposed as the reaction progresses. In other examples, the configuration and/or morphology of the reaction product may be altered by changing the composition of the electrolyte, the pH of the electrolyte, or other similar parameters. For example, an electrolyte or pH may be changed so that the reaction product remains adhered to the transition metal electrode 116. An adhered reaction product may be beneficial in some examples, such as processing a transition metal electrode that has a layered or graduated composition and that retains its configuration during its processing into a rechargeable battery cathode. Such examples are described below in more detail.

The transition metal electrode 116 may be a piece of a transition metal that is in electrical and ionic communication with the porous carbon element 104 as illustrated in FIG. 1. Examples of transition metals that may be used for the transition metal electrode 116 include transition metals used in rechargeable battery cathode materials. In some examples, these may include nickel, cobalt, manganese, aluminum, titanium, zirconium, molybdenum, tungsten, iron, zinc, copper alloys thereof, and/or intermetallic compounds thereof.

In some examples, the transition metal electrode 116 may include compositional components that are not transition metals that are added to improve conductivity, improve oxidation reaction kinetics, and/or improve the conversion of the transition metal oxide/hydroxide into a cathode composition.

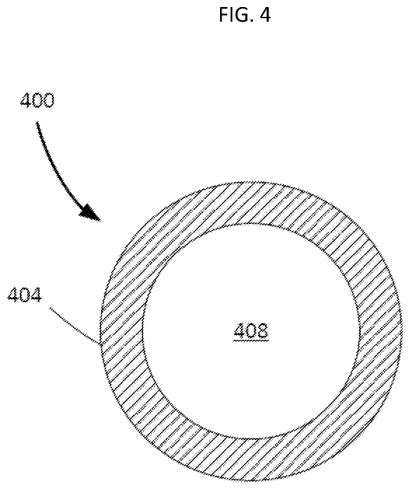

In some examples, such as those described below in Section 6 and FIG. 4, the transition metal electrode 116 may comprise one or more combinations of transition metals, non-transition metals, and/or other compounds. In some examples, components of a multi-component transition metal electrode 116 may include layers of components. In one example configuration, the transition metal electrode 116 may include a core of nickel that is surrounded or otherwise encapsulated by a layer of cobalt. While not wishing to be bound by theory, the layer of cobalt, when converted into its hydroxylated form and then reacted with Li₂CO₃ to form a cathode composition, may reduce the prevalence of nickel-based side reactions at a cathode surface. These side reactions may be caused by multiple different nickel oxide and hydroxide compositions sometimes produced during nickel oxidation reactions.

The conductor 120 may be an electrical conductor, such as a copper wire, an aluminum wire, a gold wire, and alloys thereof that connects the porous carbon element 104 and the transition metal electrode 116. In some examples, the conductor 120 may also be used to apply an electrical potential to the system 100 that initiates and sustains the oxidation reaction at the transition metal electrode 116.

A minimum applied electrical potential, applied in some examples via the conductor 120 from an external source, varies depending on the transition metal (or metals) selected for the transition electrode 116. The minimum applied electrical potential needed to promote an oxidation reaction at the transition metal oxide 116 may be an indication of the catalytic activity of the carbon catalyst used to reduce oxygen (e.g., for hydroxy anion generation) relative to the particular transition metal used as the transition metal electrode 116. An upper limit of the applied electrical potential may be based on the electrolyte. For purposes of illustration, an electrical potential applied to a water-based electrolyte may be selected to be below the voltage used for hydrolysis of water into oxygen and hydrogen. Electrolytes may be selected to sustain higher voltages.

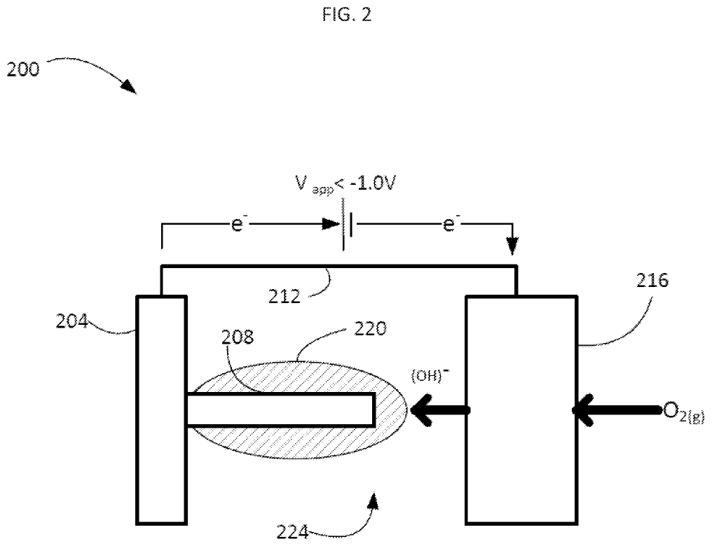

FIG. 2 is a schematic illustration of an electrochemical cell 200, in an aspect of the present disclosure. The electrochemical cell 200 is an alternative representation of some aspects of the system 100. The electrochemical cell 200 includes an electrode 204, a transition metal component 208, a conductor 212, a carbon aerogel element 216, an oxidation reaction product layer 220, and electrolyte 224.

Many of the elements shown in the electrochemical cell 200 of FIG. 2 are analogous to elements described above in the context of the system 100 shown in FIG. 1. The electrode 204 may be an electrical contact to which the transition metal component 208 (analogous to transition metal electrode 116) is in electrical communication. The conductor 212 is analogous to the conductor 120.

The porous carbon element 216 is analogous to the porous carbon element 104. In some examples, the porous carbon element 216 is a carbon aerogel material formed by carbonizing a polyimide aerogel or a poly(amic) acid aerogel. In some examples, the porous carbon element 216 is a carbonized polyurethane foam. In some examples, the porous carbon element 216 is a combination or mixture of carbonized aerogel and carbonized polyurethane foam.

In addition to the elements already described in the context of FIG. 1, FIG. 2 schematically illustrates the redox reactions that occur within the electrochemical cell 200 upon application of an external electrical voltage having a magnitude of 1 V. A magnitude of the minimum value of an applied voltage needed to promote oxidation reactions (“onset voltage”) may be determined by the particular transition metal of the component 208 and the catalytic efficiency of the porous carbon element 216. In some examples, oxidation of the transition metal within the electrochemical cell 200 may not occur for applied voltages having a magnitude less than the minimum value.

In particular, FIG. 2 schematically illustrates the exposure of the porous carbon element 216 to oxygen. In some examples, the oxygen may be gaseous such as from air or a commercial gas mixture with a concentration of oxygen that is higher than that found in air. Oxygen may enter the porous carbon element 216 that has been previously wetted with electrolyte 224.

The oxygen, upon encountering the porous carbon element 216 that also contains and/or is coated with the electrolyte 224, may be ultimately converted into hydroxy anions solvated by the electrolyte 224.

The hydroxy anions may then react with the transition metal component 208 to form one or more of transition metal oxides, hydroxides, and/or other reaction products 220 resulting from the reaction of transition metals and hydroxy anions. These reaction products are indicated by shaded region 220 in FIG. 2. While the reaction products 220 are shown in FIG. 2 as in direct contact with the transition metal component 208, this need not be the case. As indicated above, different electrolyte compositions may produce different physical configurations in the reaction products 220. For example, the presence of chloride in the electrolyte 224 produces reaction products 220 that separate from the transition metal component 208.

In some examples, oxygen is the cathode in the electrochemical cell 200. That is, the oxygen that encounters the porous carbon element 216 (which functions as an “air cathode”) is reduced upon operation of the electrochemical cell 200. The arrows in FIG. 2 labeled “e⁻” indicate that oxygen entering the porous carbon element 216 is the recipient of electrons generated by operation of the electrochemical cell 200. Because the quantity of oxygen may be from an inexhaustible source (e.g., from earth's atmosphere) or from a source with a number of moles that equals or exceeds the moles of transition metal in the electrode 208, the transition metal electrode 208 may be reacted to completion in some examples. In particular, the transition metal electrode 208 may be reacted to completion when fresh reaction surfaces are exposed upon separation of the reaction product 220 from the transition metal component 208. In other examples, the transition metal electrode may be reacted partially or completely upon diffusion of hydroxyl ions through an adhering layer of reaction product 220 to unreacted portions of the transition metal electrode 208.

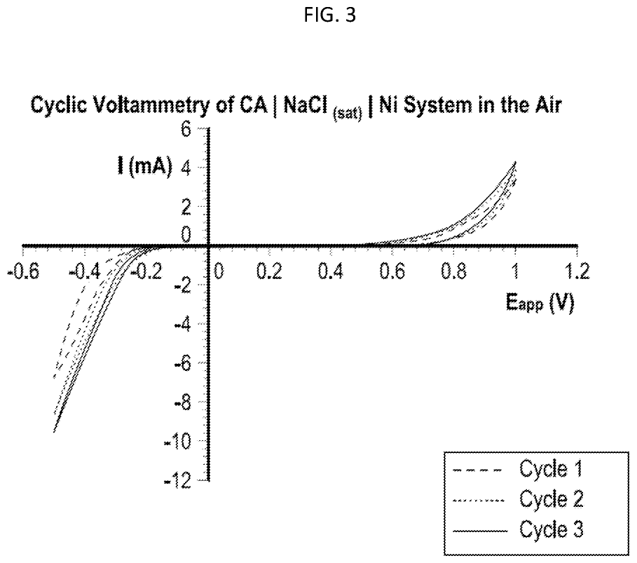

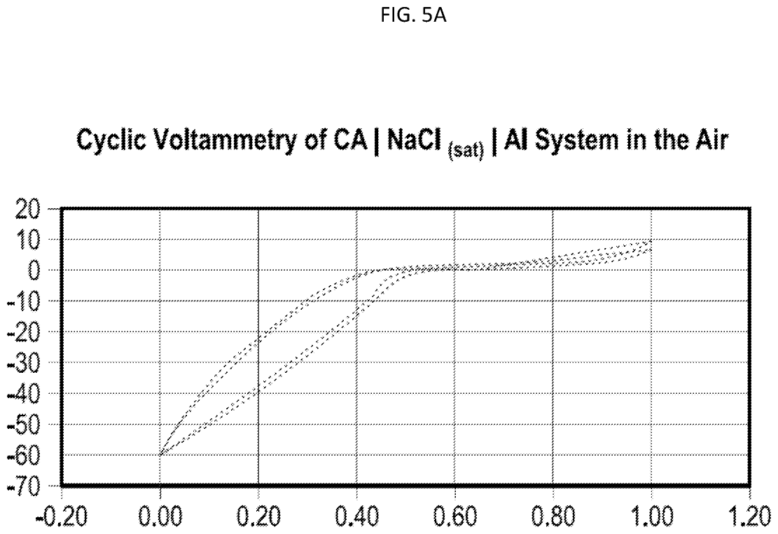

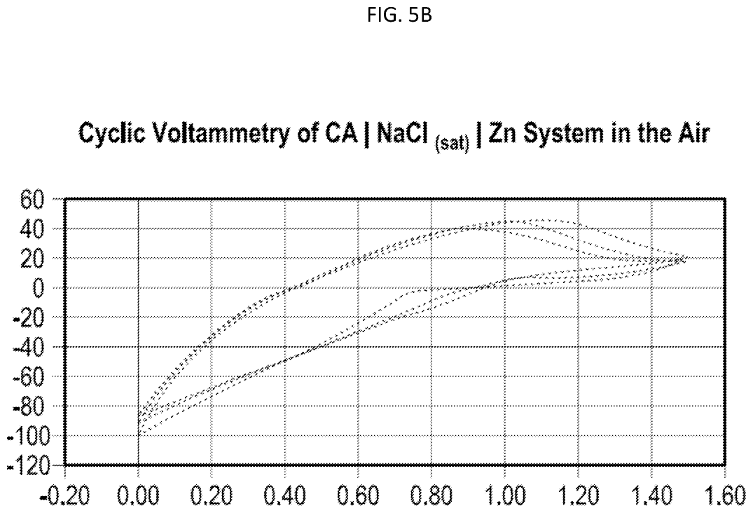

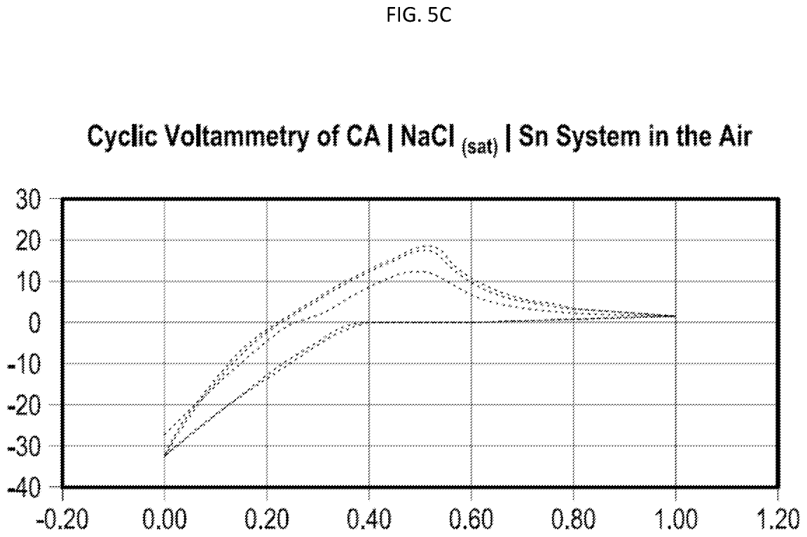

FIG. 3 illustrates cyclic voltammetry experimental data, which includes electrical currents associated (y-axis) with the electrochemical cell 100 (in a saturated NaCl(aq) electrolyte) at a plurality of different applied electrical potentials (x-axis). Data in FIG. 3 was collected at room temperature (˜20° C.+/−5° C.). In FIG. 3, the transition metal cathode is nickel (Ni). As shown, the magnitude of the current increases from near zero to several milliamperes (mA) upon application of approximately 0.2 V (i.e., between approximately 0.2 V and 0.4 V). The electrical configuration used to collect the data in FIG. 3 (and FIGS. 5A, 5B, 5C) is that schematically illustrated in FIG. 2, with the negative electrode of the external potential source applied to the porous carbon element. As can be seen, a relatively low applied voltage is sufficient to convert nickel to one or more of nickel oxide, nickel hydroxide, and/or other similar reaction products at room temperature.

### 6. LAYERED TRANSITION METAL ELECTRODE MATERIALS

In some aspects, transition metal components reacted according to one or more of the aspects described above may be layered or graduated compositions. In some examples, the transition metal component may include two or more transition metals (e.g., Ni and Co; Ni, Co, and Mn). In some examples, the multiple transition metals are combined into an alloy that may have a uniform composition or may include multiple phases. In other examples, the multiple transition metals may include an intermetallic compound instead of, or in addition to, one or more alloys. In some examples, the composition may be graduated such that an exterior surface of a transition metal component is rich in one transition metal and gradually richer in another component as a distance to a center of the component decreases.

In other aspects, such as the one illustrated in FIG. 4, the transition metal component may have an encapsulated or striated composition. As shown in FIG. 4, transition metal component 400 includes an outer layer 404 that is a first composition disposed around and in contact with an inner core 408 having a second composition that is different from the first composition. The first composition and the second composition may be, but are not limited to, any of the compositions described above as well as any combination of compositions described above.

In one aspect, the transition metal component 400 may be processed according to the techniques described above to convert the outer layer 404 to its corresponding oxidized forms (e.g., oxides, hydroxides, peroxides). Some or all of the inner core 408 may be reacted to its corresponding oxidized forms. In one instantiation of this example, the outer layer 404 may be a first composition that includes cobalt and the inner core 408 may be a second composition that includes nickel. After oxidation and conversion to a cathode material upon thermal processing with a lithium salt, a cobalt-rich surface layer may decrease the rate of occurrence of NiO-side reactions that degrade cathode performance in more traditionally configured cathodes.

### 7. SYNTHESIZING POROUS METAL OXIDE MATERIALS

Some aspects herein may be applied to synthesize microporous and/or nanoporous materials by selectively oxidizing, at room temperature, one component of a multi-component and/or multi-phase system. For convenience of illustration, a two phase alloy of a first metal and a second metal may be formed in which the first metal may oxidize at a lower applied electrical potential than the second metal (when placed in an electrochemical cell with a carbon aerogel air cathode). In this way, regions of the alloy that are rich in the first alloy may be selectively oxidized and removed from the alloy. This technique may thus generate three-dimensional nanoporous elements that may have specific surface areas that are hundreds or thousands of square meters per gram. These high surface area metal components may be used as catalyst substrates, or themselves have a high surface chemical activity. In other examples, these techniques may be used to generate light-weight metal components that have mechanical properties (e.g., fracture toughness, elastic modulus, yield strength) that are comparable or better than their non-nanoporous analogs.

FIGS. 5A, 5B, and 5C present cyclic voltammetry experimental data that illustrates how aspects herein may be used to selectively remove one phase of an alloy to produce a nanoporous metal material, as described above. These figures are analogous to FIG. 3 (using an analogous experimental configuration, such as the one shown in FIG. 2) except that: FIG. 5A illustrates cyclic voltammetry experimental results for an aluminum (Al)/carbon aerogel (CA) system; FIG. 5B illustrates cyclic voltammetry experimental results for a zinc (Zn)/carbon aerogel (CA) system; and FIG. 5C illustrates cyclic voltammetry experimental results for a tin (Sn)/carbon aerogel (CA) system. All of these data were collected from electrochemical cells using a saturated NaCl_{(aq)} solution. Also analogous to FIG. 3 are the axes in FIGS. 5A, 5B, and 5C: the x-axis indicates an applied potential difference (Volts) and the y-axis indicates a measured current (milliAmperes (mA)).

Oxidation of the metal corresponding to each of the metals shown in FIGS. 5A, 5B, and 5C occurs at a different onset potential. In these examples, the open circuit voltage (OCV) is the voltage at zero current. In the case of aluminum (FIG. 5A), the onset potential is approximately 0.5 V. In the case of zinc (FIG. 5B), the onset potential is approximately 0.9 V. In the case of tin (FIG. 5C), the onset potential is approximately 0.35 V. These figures are presented merely to illustrate the different onset potentials and open circuit voltages at which oxidation starts when the corresponding metal is placed in an electrochemical cell with a carbon aerogel air cathode, at described herein. These figures also show the maximum overpotential (i.e., the difference between OCV and onset potential) for reduction of the oxygen at the carbon aerogel air cathode. For example, a system that is not forming protective passive films and demonstrate easy oxidation reactions, such as zinc metal provides a chance to look exclusively at the activation energy on the air cathode and oxygen reduction reactions.

The differences in onset voltage may be used to selectively oxidize one metal in an alloy, but not another with a different onset voltage. For example, aluminum and zinc form a solid solution of an aluminum-rich (a) phase and a zinc-rich (q) phase. In this example, aluminum may be oxidized preferentially, leaving pores having similar dimensions to the size of the a phase regions. Annealing and compositional parameters may be selected to alter the size of these a phase regions, thereby altering the size of the pores upon their removal. While cyclic voltammetery data is not shown for copper, aluminum and copper are known to form a solid solution. The techniques described herein may also be applied to aluminum-copper alloys, as well as many other types of alloys.

Similarly, mechanical processing may also be used to alter an onset voltage of a material. Mechanical deformation (e.g., exceeding a yield stress of a material) is known to promote oxidation at the location of the deformation. Bending, compressing, cold rolling (or other types of deformation), welding, and the like may be used to encourage preferential removal of material using the techniques described above.

### 8. EXPERIMENTAL EXAMPLE

In one experimental example, a configuration similar to that illustrated in FIG. 1 was used. In this experiment, a block of carbon aerogel was placed in contact with an electrolyte solution. The electrolyte in this example was a saturated sodium chloride (NaCl) solution in distilled deionized water. The pH of the electrolyte was approximately neutral (a pH of ˜ 7). The electrolyte was contained in the soaked separator.

A nickel anode was inserted into (i.e., in direct contact) with the electrolyte solution and indirect contact with the carbon aerogel air cathode. The nickel anode was a section of pure nickel wire. A pure nickel current collector (the same material as the pure nickel anode) was placed in contact with the nickel anode. The nickel current collector was not in contact with the electrolyte. Both the pure nickel anode and the pure nickel current collector were purchased from TEMCo®.

To complete the circuit, a first end of a stainless-steel wire was placed in contact with the carbon aerogel air cathode. A second end (opposite the first end) of stainless-steel wire was placed in contact with the nickel current collector and Ni wire anode. Alligator clips were used to electrically connect the current collectors to a direct current voltage supply.

An external power source was used to apply a potential difference to the above electrochemical cell, where the carbon air cathode was connected to the negative terminal of the power source. In this example, approximately a 1 Volt (V) potential difference was applied to the carbon aerogel air cathode and the nickel current collector. In this experiment, the carbon aerogel air cathode was connected to a negative terminal of the power source and the nickel anode was connected to a positive terminal of the power source. The 1 V potential difference was selected for convenience and to avoid the parasitic water electrolysis reaction that reduces the coulombic efficiency of the system. Electrolysis of water also produces gaseous hydrogen and oxygen which additionally present a safety risk. The cyclic voltammetry data presented in FIG. 3 indicates that smaller magnitudes of voltage (e.g., as low as 0.2 V) would be sufficient to enable the oxidation of the nickel anode to occur.

The reaction was performed in an ambient atmosphere (air) at standard temperature (˜20° C.) and pressure (1 atmosphere).

The electrochemical cell was then permitted to react under the conditions described above. The pure nickel anode reacted to completion in about 160 minutes. At this point, the portions of the nickel anode in contact with the electrolyte were consumed, thereby causing an open circuit between the electrolyte and the remaining stub of the anode that is no longer in contact with the electrolyte. The reaction product was disposed on the bottom of the beaker and had a green color consistent with Ni(OH)₂, NiCO₃ or a mixture of both.

### 9. PRODUCTION OF MAGNETIC IONPS (IRON OXIDE NANOPARTICLES) FOR LFP

The present inventors have surprisingly discovered that the methods of the present disclosure can also be used to produce both magnetic and non-magnetic iron oxide nanoparticles (IONPs) by using iron as the transition metal electrode 116 in a method analogous to that depicted in FIG. 1. The magnetic and non-magnetic IONPs are known to the skilled person as various compositions of iron (II,III) oxides. These IONPs may be particularly useful in the field of battery technology because they may be used as the source of iron in lithium iron phosphate (LFP) batteries.

First, in the disclosed method of producing magnetic IONPs, iron is used as the transition metal anode and a porous carbon element 104 may be used as described above, reducing the activation energy for the reduction of oxygen thereby enabling the electrically connected iron metal to participate in a room temperature redox reaction. The present inventors have found that a carbonized polyurethane foam maybe used in place of carbon aerogel as the element 104. In fact, the inventors believe that any porous carbon material may be used.

A carbonized polyurethane foam may be advantageous in the method of producing magnetic IONPs because it may be more chemically and mechanically stable than a carbon aerogel in the reaction that will be described below. In addition, the inventors believe that a combination of a carbonized polyurethane foam and carbon aerogel could be used in combination e.g., carbon aerogel stabilized within the pores of the carbonized polyurethane foam, wherein the carbonized polyurethane foam provides additional mechanical stability to the carbon aerogel material.

The production of magnetic IONPs may be described with reference to FIG. 2, already explained above wherein reference numeral 126 indicates the carbon aerogel element and/or carbonized polyurethane foam and reference numeral 208, the transition metal component, is a piece of iron for example an iron foil. For the production of magnetic IONPs, the inventors have found that sodium chloride may be used as the electrolyte 224. By way of example, the concentration of the electrolyte 224 may be one molar (1M). However, the electrolytes are not so limited. It is to be appreciated that the electrolyte 224 can be the solution of a salt of an alkali metal with a halogen, for example sodium chloride or potassium chloride and that the concentration of the electrolyte may be from approximately 0.1M-2.0M, 0.2M-1.5M, 0.5M-1M, or up to the concentration of a saturated solution of the electrolyte, for example up to around 6.14 M (i.e., saturated NaCl solution at room temperature). The corrosion rate of the anode metal increases monotonically with the concentration of the salt in the electrolyte. Particular examples may be 1M and 0.2M in certain aspects.

The electrolytic reaction proceeds to oxidize the iron metal 208 to produce “green rust” which is iron (II) hydroxide (Fe(OH)₂) and/or its partially oxidized form, Fe(OH)₂₋ₓOₓ. In practice this material precipitates and falls to the bottom of the reaction chamber and can be removed, for example by gravity or by pumping to a separate chamber. In the separate chamber the green rust may be allowed to stand and further oxidize partially under ambient conditions to form lepidocrocite (γ-FeO(OH)). This resulting (partially oxidized) iron hydroxide may be further forced to oxidize by bubbling air in basic conditions (e.g., pH>8) to yield magnetic IONPs and in particular maghemite γ-Fe₂O₃. The air bubbling may proceed at volumes of around 1-5 L/min, for example around 2 L/min. Magnetic IONPs (e.g., magnetite, maghemite, and/or their solid-solutions) are ferrimagnetic and can be magnetically separated from the reaction mixture (noting that iron oxy/hydroxides are paramagnetic). The recovered IONPs are then washed and dried for onward processing for example as the iron source in LFP synthesis.

Magnetic IONPs produced as described above have undergone XRD analysis and it has been confirmed that the observed XRD pattern matches the calculated pattern of the cubic spinel. The magnetic particles produced in this method are in the form of nanoparticles i.e. particles having a size in the region of 20-100 nm when observed using scanning electron microscopy. It has surprisingly been observed that the concentration of the electrolyte used in the process may have an influence on the particle size of the produced particles. For example, a 1M NaCl electrolyte has been shown to produce particles having a size of around 60-70 nm (specific surface area 22.46 m²/g) whereas a 0.2M KCl electrolyte has been shown to produce particles having a size of 20-40 nm (specific surface area 40.22 m²/g). Thus, the process may be tailored to produce particles of different size, depending on the intended end-use. Experimental example of making maghemite (γ-Fe₂O₃) nanoparticles.

The reaction was carried out in a 15 L rectangular plastic container filled with 10 L of 1 M NaCl solution, prepared in tap water. The air cathode comprised of four rectangular blocks of carbon foam, with dimensions of 4×10×16 cm. The air cathode blocks were secured in the reactor mechanically and connected electrically. Each carbon foam block has a central hole drilled along its length, through which air can be pumped. However, for the synthesis of magnetic γ-Fe₂O₃ (maghemite) no forced air diffusion is needed.

Foils of pure iron (˜15×2×0.04 cm) anodes were introduced between the carbon air cathodes and connected electrically. An overhead mixer with a mixing rate of ˜250 rpm was introduced in the reactor to homogenize the concentration of hydroxide reagents produced by the reduction of atmospheric oxygen. To begin, a voltage of 1 V was applied to the electrodes. Immediately, a current of ˜2 A starts to flow due to the following reactions:

½O₂+H₂O+2e→2OH⁻ Cathode:

Fe→Fe²⁺+2e Anode:

The magnitude of the current increases with time to around 4 Amperes(A), as corrosion increases the surface roughness of the Fe anode. The release of Fe²⁺ and OH⁻ ions in the electrolyte beyond the solubility product constant results in the formation of nanoparticulate Fe(OH)₂, i.e., the green rust. Partial oxidation of green rust through contact with atmospheric oxygen causes some oxidation to intermediate oxidations states, such as FeO₁₋ₓ(OH)₂₋ₓ (i.e., lepidocrocite) which adopts a cubic crystal structure similar to maghemite. After ˜24 h of reaction, the Fe anodes are corroded.

In a second step, the lepidocrocite fine sludge is extracted, the pH of the solution is increased to 9 by adding the appropriate amount of Na₂CO₃ and air is bubbled (1 L/min, 3 h) through the solution for oxidative dihydroxylation to maghemite, γ-Fe₂O₃. A magnet test is used to conclude complete conversion of lepidocrocite to maghemite. Next, the nanoparticulate maghemite is readily separated from the sodium chloride/carbonate electrolyte by magnetic separation and subsequent washes until free from the chloride ion (2˜3 washes with 1 L water each time).

### 10. PRODUCTION OF NON-MAGNETIC IONPS FOR LFP

The production of non-magnetic IONPs may proceed in part analogously to the production of magnetic IONPs described above, with reference to FIG. 2, wherein reference numeral 126 indicates the carbon aerogel element and/or carbonized polyurethane foam with air is pumped through the central hole at a rate of 2 L/min. and reference numeral 208, the transition metal component, is a piece of iron for example an iron foil. For the production of non-magnetic IONPs, the inventors have found that sodium chloride may be used as the electrolyte 224. By way of example, the concentration of the electrolyte 224 may be one molar (1M). However, the electrolytes are not so limited. It is to be appreciated that the electrolyte 224 can be the solution of a salt of an alkali metal with a halogen, for example sodium chloride or potassium chloride and that the concentration of the electrolyte may be from approximately 0.1M 2.0M, 0.2M-1.5M, 0.5M-1M or up to the concentration of a saturated solution of the electrolyte, for example up to around 6.14 M (i.e., saturated NaCl solution at room temperature). Particular examples may be 1M and 0.2M in certain aspects.

The electrolytic reaction proceeds to oxidize the iron metal 208 to produce “green rust” which is iron (II) hydroxide Fe(OH)₂ and/or its partially oxidized form, Fe(OH)₂₋ₓOₓ. In a first alternative method of the disclosure this material precipitates and falls to the bottom of the reaction chamber and can be removed, for example by gravity or by pumping to a separate chamber. In the separate chamber the green rust may be further forced to oxidize by bubbling air to yield non-magnetic IONPs and in particular goethite (FeOOH). The air bubbling may proceed at volumes of around 1-5 L/min, for example around 2 L/min. The nanoparticulate goethite is separated from the solution by at least one, and preferably a plurality of cycles of washing and decantation, or filtration, or centrifugation. The recovered IONPs are then dried for onward processing for example as the iron source in LFP synthesis.

In an alternative method of the disclosure the Fe(OH)₂ formed in the electrolytic reaction may be directly oxidized to goethite nanoparticles in situ by the introduction of oxygen to the electrochemical cell, for example by bubbling air, optionally and conveniently through the porous carbon anode during electrolysis. The air bubbling may proceed at volumes of around 1-5 L/min, for example around 2 L/min. Such alternative method may be carried out in neutral to slightly acidic pH conditions (e.g., 5<pH<7, such as pH of about 6). The nanoparticulate goethite is separated from the sodium chloride electrolyte by analogous cycles of washing and decantation, or filtration, or centrifugation. The recovered IONPs are then dried for onward processing for example as the iron source in LFP synthesis.

### Experimental Example of Making Goethite (α-FeOOH) Nanoparticles

The reaction was carried out in a 15 L rectangular plastic container filled with 10 L of 1 M NaCl solution, prepared in tap water. The air cathode comprised of four rectangular blocks of carbon foam, with dimensions of 4×10×16 cm. The air cathode blocks were secured in the reactor mechanically and connected electrically. Each carbon foam block has a central hole drilled along its length, through which air can be pumped as needed. Foils of pure iron (˜15×2×0.04 cm) anodes were introduced between the carbon air cathodes and connected electrically. An overhead mixer with a mixing rate of ˜250 rpm was introduced in the reactor to homogenize the concentration of hydroxide reagents. To begin, a voltage of 1 V was applied to the electrodes while air is pumped through the carbon cathodes at a rate of 2 L/min. Immediately, a current of ˜4 A starts to flow due to the following reactions:

½O₂+H₂O+2e→2OH⁻ Cathode:

Fe→Fe²⁺+2e Anode:

Due to the high concentration of dissolved O₂ in the electrolyte, the as formed Fe(OH)₂ nanoparticles oxidize directly to goethite nanoparticles. Under the above circumstances, complete etching of Fe anode occurs within 7-10 h.

Next, the nanoparticulate goethite is separated from the sodium chloride electrolyte by successive cycles of washing and decantation, or filtration, or centrifugation.

While not wishing to be bound by theory, the inventors believe that with all metals (M) capable of forming stable divalent cations (e.g., Fe, Mn, Ni, Co, Cu, Zn, Sn, etc.) the immediate reaction product formed at the surface of the M anode is the metal double hydroxide salt, M(OH)₂. With metals for which +2 is the highest possible oxidation state (e.g., Zn) or where oxidation states higher than +2 are not energetically favorable to form at low temperature in air (e.g., Ni, Co, Cu), M(OH)₂ seems to be the final reaction product as well. For the specific case of Fe (and Mn), as +3 oxidation states are readily available in air at low temperature, M(OH)₂ tends to be an intermediate, leading to higher oxidation states depending on the potential-pH and oxidation conditions.

In the specific example of Fe, it seems that Fe(OH)₂ and/or its partially oxidized form, FeOₓ(OH)₂₋ₓ, i.e., the green rust, is the first intermediate that forms during electrolysis. Without any specific further treatment at neutral pH, green rust oxidizes slowly to goethite, FeO(OH). On the other hand, increasing the pH to above 8 and controlled oxidation by air, in the described method of the invention yields maghemite, Fe₂O₃ (or Fe_{8/3}V_{1/3}O₄ in magnetite's spinel notation, where V=Vacancy). Due to availability of the +3 oxidation state for manganese, similar transformations are expected.

The inventors have found that either magnetic or non-magnetic IONPs can be produced by the methods of the present disclosure, by controlling the reaction conditions and in particular the oxygen from air that is available for oxidation. In the examples above, both performed at the same scale (15 L electrolytic reactor, 10 L electrolyte) the limited oxygen in the reactor when no air is bubbled through the carbon anode allows the green rust to oxidize to lepidocrocite FeO(OH), which later undergoes forced oxidation by air bubbling in alkaline conditions to magnetic maghemite Fe₂O₃. In the alternative, bubbling air during electrolysis in basic conditions causes the green rust to quickly oxidize directly to non-magnetic goethite FeO(OH). Thus it is the air and therefore oxygen that is introduced into the electrolyte which drives the oxidation in situ to the alpha form of the iron(III) oxide-hydroxide i.e. goethite, rather than the gamma form lepidocrocite. However, the inventors have also observed that when performing these reactions at a smaller scale (e.g., 1.5 L electrolyte), even with air bubbling through the carbon cathode, the reaction proceeds to lepidocrocite and then later maghemite. Without wishing to be bound by theory it is believed that in the smaller scale there is insufficient oxygen in the electrolyte to directly oxidize the green rust to goethite.

While the magnetic IONPs produced by methods of this disclosure have been described as useful for synthesizing LFPs, magnetic IONPs have many industrial uses such as in catalysts, in the defense industries e.g., as Microwave and Radar Absorbing Materials (RAMs), as ferrofluids, for recording tape, in remediation of pollution and in medical applications.

The method of producing magnetic IONPs as described is semi-continuous in that the electrochemical reaction may proceed in a first vessel and the product of the reaction may be transferred to a second vessel using a pump as described above while the electrochemical reaction continues and does not need to be stopped. The electrolyte may be reused thereby avoiding waste.

Table 1 presents particle size and specific surface area data for various experimental conditions. It will be noted that some embodiments include ball milling to access specific surface areas that are unexpectedly as much as 10 times greater than commercially available materials.

TABLE 1
Particle size and specific surface areas

| | | | Specific | |
|---|---|---|---|---|
| | Specimen | | surface area | Particle size |
| # | ID | Method of preparation | (m²/g) | (nm) |
| 1 | α-Fe₂O₃ | Thermal decomposition of | 9.9463 | ~100 |
| | | FeC₂O₄ in the air at 350° C. for 1 h | | |
| 2 | γ-Fe₂O₃ | Corrosion of Fe foil in the air cell | 22.4580 | ~60 |
| | | 1M NaCl electrolyte 1.1 V | | |
| | | applied potential | | |
| 3 | γ-Fe₂O₃ | Corrosion of Fe foil in the air cell | 40.2216 | ~30 |
| | | 0.2M KCl electrolyte 1.1 V | | |
| | | applied potential | | |
| 4 | LFP@C | Prepared from item #3: | 20.9905 | 50-500 |
| | | 1. γ-Fe₂O₃ + LiH₂PO₄ + PAA + H₂O; | | |
| | | 2. ball milled at 400 rpm for 2 h; | | |
| | | 3. Heated at 110° C. to dryness; | | |
| | | 4. Calcined at 700° C. for 3 h. | | |

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. A method comprising:
configuring an electrochemical cell that includes:
a transition metal anode;
a catalyst;
a source of oxygen, wherein the oxygen functions as a cathode in the electrochemical cell;
an electrolyte in contact with the transition metal anode and the catalyst;
permitting the oxygen to be reduced by the catalyst, the reduction of oxygen generating hydroxy anions in the electrolyte; and
allowing the hydroxy anions to react with the transition metal anode, wherein the reaction oxidizes the transition metal of the transition metal anode.

2. The method of claim 1, further comprising applying an electrical potential to the electrochemical cell.

3. The method of claim 1, wherein the reduction of the oxygen and the oxidation of the transition metal oxide is performed at one or more temperatures between 15° C. and 35° C.

4. The method of claim 1, wherein the transition metal anode includes nickel.

5. The method of claim 4, wherein the reaction of the hydroxy anions with the transition metal anode that includes nickel results in at least nickel hydroxide.

6. The method of claim 1, further comprising reacting the oxidized transition metal with a lithium salt to produce a rechargeable lithium-ion battery cathode material.

7. The method of claim 1, wherein the transition metal anode includes iron.

8. The method of claim 7, wherein the electrolyte is a solution of an alkali metal halide, for example sodium chloride.

9. The method of claim 7, further comprising separating iron (II) hydroxide Fe(OH)₂ and/or its partially oxidized form, Fe(OH)₂₋ₓOₓ from the electrochemical cell, transferring the iron (II) hydroxide Fe(OH)₂ and/or its partially oxidized form, Fe(OH)₂₋ₓOₓ to a reaction vessel and oxidizing at a pH greater than 7.

10. The method of claim 9, further comprising magnetically separating magnetic IONPs from the reaction vessel.

11. The method of claim 7, further comprising introducing oxygen into the electrochemical cell, preferably by air bubbling.

12. The method of claim 7, further comprising separating non-magnetic IONPs from the electrochemical cell using physical separation.

13. The method of claim 1, wherein the catalyst comprises a porous carbon material.

14. The method of claim 1, wherein the catalyst comprises a carbon aerogel.

15. The method of claim 14, wherein the carbon aerogel comprises one or both of a monolithic carbon aerogel element or a particulate carbon aerogel element.

16-20. (canceled)

21. A composition comprising:
a nanoparticle comprising iron having a characteristic dimension of from 20 nm to 1000 nm; and
having a specific surface area of from 10 meters² (m²)/gram(g) to 65 m²/g.

22-29. (canceled)

30. A composition comprising:
a LiFePO₄ (LFP) nanoparticle having a characteristic dimension of from 20 nm to 1000 nm; and
having a specific surface area of from 10 meters² (m²)/gram(g) to 65 m²/g.

31-37. (canceled)
